(19) United States
(12) Patent Application Publication
(10) Pub. No.: US 2020/0292290 A1
(43) Pub. Date: Sep. 17, 2020

(54) Symmetrical Measuring Tool

(71) Applicant: David W. Hakola, Dayton, OR (US)

(72) Inventor: David W. Hakola, Dayton, OR (US)

(21) Appl. No.: 16/351,902

(22) Filed: Mar. 13, 2019

(51) Int. Cl. G01B 3/00; G01B 3/56

(52) U.S. Cl. CPC G01B 3/004; G01B 3/56

(57) ABSTRACT

A grid pattern which includes a transparent window and handle is provided herein. Levelling and angle measurement components are provided that allow a user to determine balance and symmetry when working with subjects and the present invention. A hand held or floor stand can be used to steady the invention,

### CROSS-REFERENCES TO RELATED APPLICATIONS

This application claims priority to U.S. Provisional Patent Application Ser. No. 62/647,001 filed on Mar. 23, 2018, entitled “Symmetrical Measuring Tool”, the disclosure of which is hereby incorporated by reference.

### BACKGROUND OF THE INVENTION

This invention relates to taxidermy forms and mannequins and, more particularly, to a taxidermy method for properly aligning head and face members using a symmetrical measuring tool.

Part of the thrill or reward of the game animal hunt resides in obtaining a decorative trophy for display in the home or office. Also, there is considerable competition among hunters and taxidermists in obtaining the most attractive trophy. Numerous sportsmen are attracted to competitive shows wherein game animal trophies are displayed and judged. Some of the criteria used in judging of the trophies include an anatomical valuation where features such as ears, eyes, eyelids, mouth and the nose are judged for criteria including symmetry, location, and attitude. There is also a craftsman and technical valuation of the trophy that examines such features as alignment of animal features.

In taxidermy, the goal of the artist is to produce a finished mount that looks as close to the original animal as possible. The living animal, by nature, has many symmetrical parts that the taxidermy artist aspires to recreate. The ear of a deer, for example, consists of the muscle structure of the ear butt and the ear itself. When the ears are in the same position, the ear butt muscles will essentially be of the same shape and size and position of attachment to the deer head. As the ears move, the ear butt muscles may change shape and it's up to the taxidermist to accurately shape the ear butt clay to be anatomically correct.

Another object of the present invention is to provide an improved apparatus for mounting animal head skins onto a mannequin that results in the proper aligning of ears and antlers so that the mounted head has a relatively symmetrical and normal look.

Another object of the present invention is to provide a measuring tool for measuring 2 or 3-dimensional work of art in progress to determine its visual balance and make any necessary adjustments.

Taxidermy involves the preservation of animal skins and mounting the animal head skins over molded animal head mannequins which replicate the sub-dermal structures of the animal to be preserved. In addition to the skin, the taxidermist will further attach artificial eyes, noses, antlers, and the like, to the mannequin to further replicate the true appearance. The end product is secured to a wall plaque or the like, and typically mounted on a wall as a trophy.

Conventional taxidermy head form mannequins provide pre-formed eye socket cavities into each of which the taxidermist must mount separate artificial glass eyepieces. When modeling a taxidermy form, the eyes must be set within the eye sockets in a precise manner at the proper depth and angle. To allow for tilting of eyes relative to the sockets, the eye sockets are made relatively deep, and the eyes are then embedded in a layer of modeling clay, two-part epoxy or other malleable material. The taxidermist may use the same clay or epoxy in the eye and nose areas to sculpt, for example, a more detailed anatomically correct eyelid area over the eye to recreate the proper eyelid and muscle definition. A layer of hide paste is then applied to the surface of the mannequin. The head skin of the animal is then pulled over the form with the eye set in, seams are sewn and left to dry.

A taxidermist spends considerable time and skill to properly adjust the depth, shape and alignment of the eyes and ears and adjustment of hair patterns. If the taxidermist does not apply the correct thickness of clay, the eyes may appear sunken or protruding. It is also important to align the angle of the eye, and particularly the pupil, in relation to the form so that the eye appears to be symmetrical and as natural as possible. Some animals, for example, a cat, have vertical elongated pupils, whereas other animals, for example, a deer, have horizontal elongated pupils and other animals, for example, a bear, have round pupils. If the eye is of the elongated pupil type, there are a number of axes on which the eye must be properly aligned for it to appear lifelike and to constitute a correct anatomical representation of an animal. In addition, the eyes of different animals are naturally set at different angles with regard to the “straight ahead” direction. For example, a dog's eyes are at almost 0 degrees to straight ahead, whereas some bird species have their eyes at almost 90 degrees to straight ahead. A white-tailed deer's eyes are at approximately 45 degrees to straight ahead. Moreover, there are variations in shape and size of the eyes, even for different sized animals of the same species.

The taxidermy head forms may lack detail in particular facial contour features due to the difficulties in molding the areas around the antlers, ears, eyes, eyelids, nose, nostrils, septa, and lips. The alignment of the correct facial anatomical contour features is demanding of considerable time and skill of the taxidermist. In the past, there have been problems correctly positioning and securing of the skin in the correct anatomical position over the face of the animal being mounted. Nose and lip models are available as discrete components, to be attached separately to the taxidermy form. However, the taxidermist still must affix the nose and the lips parts to the head model and to dimensionally match the artificial parts to the skin, in order to obtain a life-like taxidermy model.

For the foregoing reasons there is a need for a taxidermy balancing and levelling tool which allows components of an animal's hide or head to be easily and accurately positioned.

### BRIEF SUMMARY OF THE INVENTION

An example embodiment of the present invention is directed to a grid pattern which includes a transparent window and handle. Levelling and angle measurement components are provided that allow a user to determine balance, symmetry and proportion when working with subjects and the present invention. A hand held or floor stand can be used to steady the invention,

One object is to provide a symmetrical measuring tool for the measuring of a 2 or 3-dimensional work of art in progress to determine its visual balance and symmetry so as to make necessary adjustments.

Accordingly, it is an object of the present invention to provide an improved apparatus and process for taxidermists in preparing animal head trophies.

Another object is to provide a Symmetrical Measuring Tool that will measure the vertical and horizontal planes.

Another object is to provide a Symmetrical Measuring Tool that will measure angles.

Another object is to provide a Symmetrical Measuring Tool that will give an overall view of the subject to determine balance, symmetry and proportion with an over view of the subject through a grid pattern.

Another object is to provide a Symmetrical Measuring Tool that can be used as a teaching aid. An advantage of the present invention is that the grid pattern window can be set up for prolonged periods of time on a stand, and by using the horizontal grid letters and the vertical grid numbers to identify areas of intersections, a teacher to student or worker to co-worker, can easily refer to a specific area as identified with the grid pattern in their discussions.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE FIGURES

FIG. 1 is a front view of a clear window and handle with a grid pattern printed on it as according to an embodiment of the present invention.

FIG. 2 is a right-side view of a clear window and handle with a grid pattern printed on it as according to an embodiment of the present invention.

FIG. 3 is a front view of an exemplary operation of the present invention showing the method of holding the symmetry measuring tool measurement string as according to an embodiment of the present invention.

FIG. 4 is a front view of an exemplary operation of the present invention showing the method of measuring the forward tilt angle of a deer ear sculpture as according to an embodiment of the present invention.

FIG. 5 is a front view of an exemplary operation of the present invention showing the method of measuring the outward angle of a deer ear sculpture as according to an embodiment of the present invention.

FIG. 6 is a front view of an exemplary operation of the present invention showing the method of using the grid pattern to compare the left and right ear tip heights, ear butt muscles, and overall symmetry of a deer sculpture of the present invention.

FIG. 7A is a rear view showing the overall operation of the present invention as according to an embodiment of the present invention.

FIG. 7B is an illustration showing the arrangement of clay deer dear butts and plastic ear liners used in taxidermical procedures.

FIG. 8 is view of the present invention showing the clear window with grid pattern mounted to a floor stand as according to an embodiment of the present invention.

FIG. 9 is a view of the present invention showing a larger clear window with attached level, larger grid pattern, and hole for mounting on to a stand as according of an embodiment of the present invention.

FIG. 10 is a view of the present invention showing a smaller clear window with degree markers at the bottom of the smaller clear window movably mounted to a larger window with a grid pattern as according to an embodiment of the present invention.

FIG. 11 is a view of the present invention showing a smaller clear window with degree markers at the bottom of the smaller clear window movably mounted to a larger window with a grid pattern attached to a floor-standing stand as according to an embodiment of the present invention; and

FIG. 12 is an embodiment of the present invention attached to an extendable stand to gain top down and bottom up perspectives of a subject.

### DETAILED DESCRIPTION OF THE PRESENT INVENTION

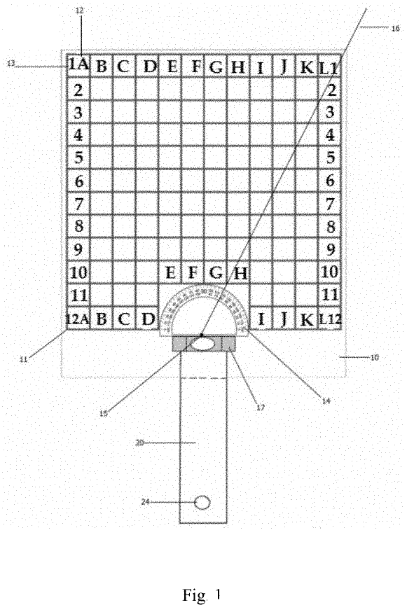

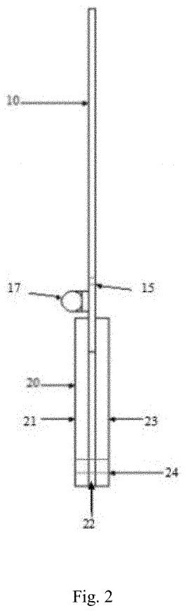

Referring now to FIGS. 1 and 2 that will be discussed together, there are shown views of a clear window (10) and handle (20) with a grid pattern (11) printed on it as according to an embodiment of the present invention. On the grid pattern (11) letters (12) are placed in a horizontal pattern in ascending order. There is one letter (12) placed in each square so as to identify the x-axis location of each grid element. Numbers (13) are placed in a vertical pattern along in ascending order. There is one number (13) in each square so as to identify the y-axis location of each grid element.

A degree indicator (14) is placed along the bottom of the clear window (10). The degree indicator (14), in some embodiments, can show a range of degrees from 0 to 180. Other degree ranges may exist in other embodiments of the present invention. A degree measurement component (16) is shown extending from the bottom-center of the window (10) to the upper-right corner of the window (10). The degree measurement component (16) is extended from an origin point (15) to along a particular path to indicate the angle being measured. The path can be the direction of an animal facial component, such as the path of an ear, or can be tip of an animal component such as an ear, nose, or the like. The degree measurement component (16) can be a flexible member such as a string, or a solid member such as a piece of wood or metal.

A levelling indicator (17) is placed along the bottom of the clear window (10). The levelling indicator (17) is used to determine whether the invention is being held at a level angle when in use. The indicator can be a bubble level or any other component capable of indicating whether the device is being held level.

In this embodiment of the present invention, a handle (20) is attached to the clear window (10). The handle allows embodiments of the present invention to be easily manipulated around an animal during the taxidermy process. Further, in this embodiment a hole is provided in the handle (20) so that the invention can be easily stored when not in use. The clear window (10) is placed between front (21) and back (23) components of the handle (20). This places the window (10) in the center (22) of the handle.

The grid pattern (11) aids in the visual measurement of the subject symmetry. A subject is seen through the clear window (10) and the grid pattern (11) appears to be overlaid on the subject. The letters (12) and numbers (13) work together to identify intersecting areas within the window's (10) grid pattern (11). When two or more subjects or components of a subject are compared, the corresponding grid coordinates are used to determine whether there is symmetry, proper alignment, or correct orientation between items being compares.

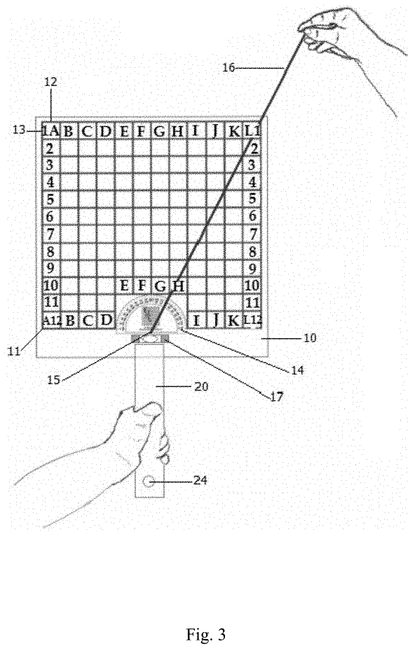

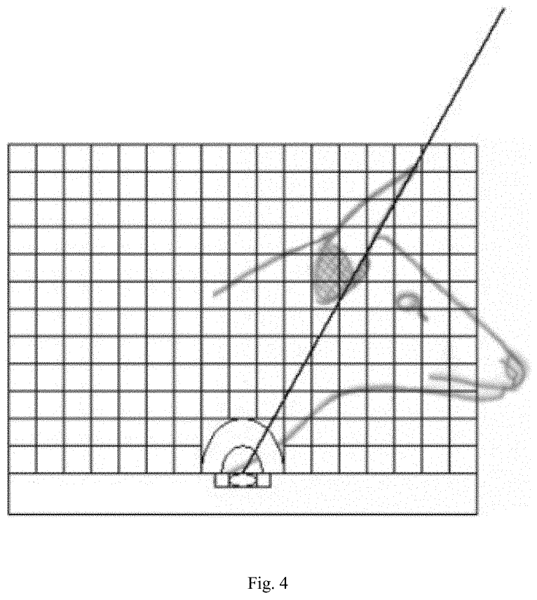

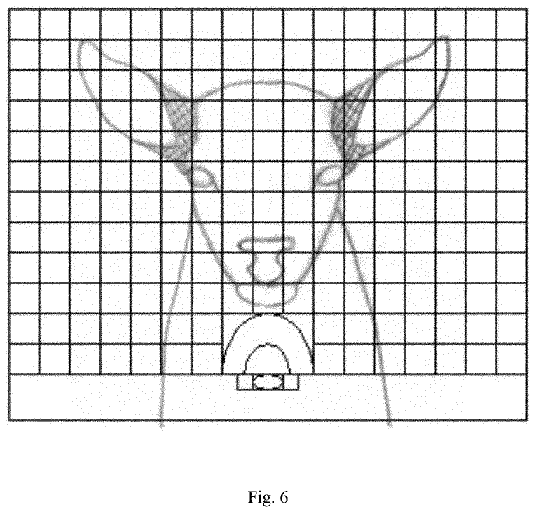

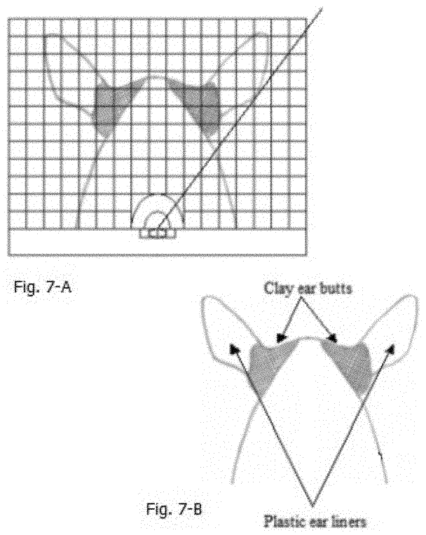

Referring now to FIGS. 3-7 that will be discussed together, there are shown views of the present invention and methods for using the invention. In an exemplary use of the invention, the forward tilt of a deer's ear (FIG. 4) can be determined by overlaying the clear window (10) and grid pattern (11) over the side of the deer's head. If the origin point (15) is placed at a correlating position on the left and right side of the deer head, then the forward tilt angle of the deer's ears can be determined by extending the degree measurement component (16) from the origin point (15) along a path following the deer's ear. The angle of tilt is measured by examining where the degree measurement component (16) crosses the degrees of the degree indicator (14). When the opposite side of the deer's head is measured, the forward tilt of the other ear can be measured by obtaining the corresponding angle by following the same method of measurement described immediately above.

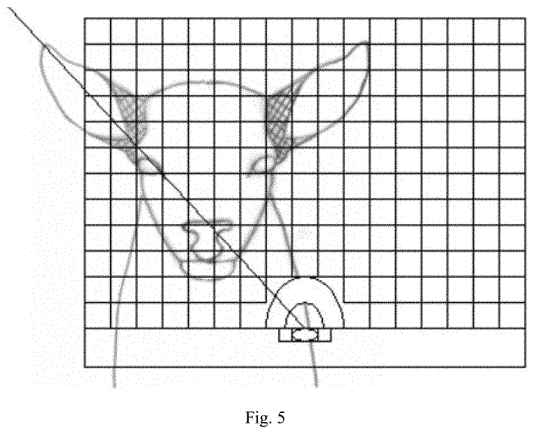

A similar procedure can be used to measure the outward tilt of a deer's ear. The clear window (10) and grid pattern (11) is overlaid over the front of the deer's face. By placing the origin point (15) on correlating left-and-right points on the deer, comparative outward tilt angles are obtained. As illustrated in FIG. 5, the origin point (15) is placed on the deer's left shoulder. The degree measurement component (16) is extended to the tip of the deer's right ear. The degree of tilt is measured by examining where the degree measurement component (16) crosses the degree indicator (14).

To measure the outward tilt of the other ear, the clear window (10) and grid pattern (11) is overlaid over the front of the deer's face but the origin point (15) is placed on the mirror-image part of the deer, in this case the corresponding point on the other shoulder of the deer. The origin point (15) is placed on the deer's right shoulder. The degree measurement component (16) is extended to the tip of the deer's left ear. The degree of tilt is measured by examining where the degree measurement component (16) crosses the degree indicator (14).

In addition to measuring component degree tilt, the present invention can be used to measure component size and location. In an exemplary use of the present invention, clay ear butts can be measured by recording their respective x-axis and y-axis coordinates. By way of example, the left clay ear butt can be observed to extended from square E4 to H4. The right clay ear butt can be observed to extend from square K4 to N4. Since each ear butt extends across the same number of horizontal squares, it can be said they are the same length. Similar measurements can be made for components extending in the vertical components, or components with X and Y vectors.

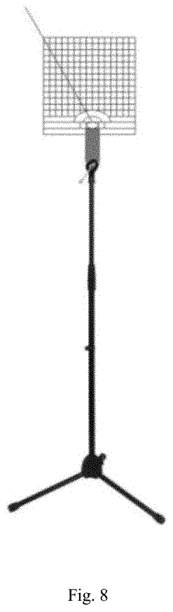

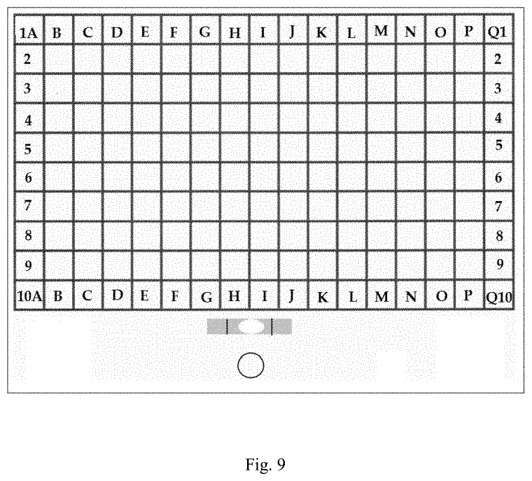

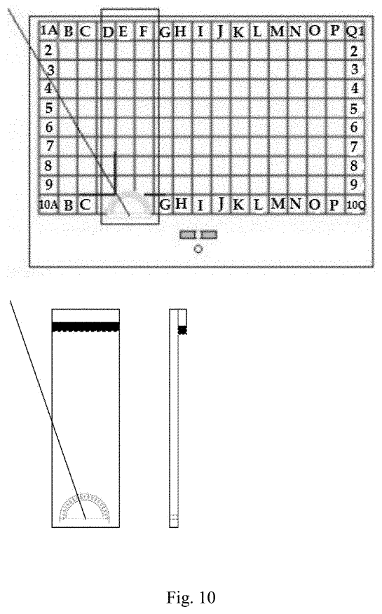

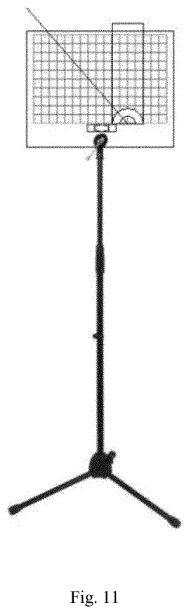

Referring now to FIGS. 8-12 that will be described together, there are alternative embodiments of the present invention including an embodiment that can be mounted to a floor stand. This embodiment allows users to affix the invention in a manner that not only allows for hand-free use, but allows them to position the invention in an elevated or top-down position. The floor stand can mount to the clear window (10) where the handle (20) would otherwise mount.

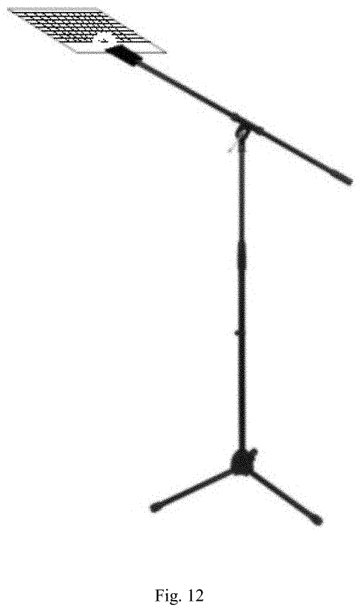

Floor stands can be of adjustable height and can be equipped with an extendable boom as seen in FIG. 12. The boom allows for the top-down view by positioning the window (10) and grid lines (11) in a horizontal orientation over a subject. This is particularly useful for orienting the horizontal position of animal elements such as antlers or ears.

Another embodiment of the present invention provides a smaller clear screen that is designed to slide left and right over the larger window (10). The smaller screen has a degree indicator (14), an origin point (15) and a degree indicator. The smaller screen is designed to slide horizontally across the window (10) so that multiple angular measurements can be made without having to re-orient or adjust the position of the window (10) and grid lines (11). The small screen is constructed so that it is clear and the grid lines (11) of the larger window (10) are visible through the smaller screen.

Some embodiments of the present invention can have lights attached to enhance performance of the invention in poorly-lit conditions. Other embodiments of the present invention can have mirrors attached to redirect light toward the subject. The lights and mirrors can be fixed in-place or adjustable so as to allow for light to be directed at the subject from a variety of angles.

To measure angles, the user stands squarely facing the subject while holding the symmetry measuring window (10) with one hand and with the fingers of the other hand, holds onto the loose end of the degree measurement component (16). While keeping the levelling component (17) centered, the user frames the subject within the symmetrical measuring tool window (10). The user adjusts the degree measurement component (16) along the arc of the degree indicator (14) until it lines up with the targeted angle of the subject to be read in degrees and noted from the degree indicator (14).

To measure the symmetry or proportions of the subject, using the grid pattern (11), the user stands square to the subject and with one, or even two hands, holds the symmetry measuring tool at arms-length while using the levelling component (17) and framing the subject within the window's (10) grid pattern (11). Angles can be measured using the degree measurement component (16) and the degree indicator (14). The size of components can be determined based on the number of squares taken up by each component.

In some methods, users can draw a grid pattern on a photograph or canvas and. The present invention is set up on a stand next to the photograph or canvas. The present invention can be used outdoors to capture 3 dimensional subjects to the user's canvas. Prints can also be placed under my symmetrical measuring tool for an instant grid pattern to follow while using the same grid transfer technique to a painted surface. The user can copy what is observed through the screen (10) by placing components within the gridlines onto the canvas or photograph that they are working with.

Unless otherwise defined, all technical and scientific terms used herein have the same meaning as commonly understood by one of ordinary skill in the art to which this invention belongs. Although methods and materials similar to or equivalent to those described herein can be used in the practice or testing of the symmetrical measuring tool, suitable methods and materials are described above. All publications, patent applications, patents, and other references mentioned herein are incorporated by reference in their entirety to the extent allowed by applicable law and regulations. The symmetrical measuring tool may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

I claim:

1. A tool for measuring symmetry comprising:
a clear window, the clear window having a grid pattern printed on it;
a degree indicator that is located on a portion of the clear window;
a degree measurement component that extends from an origin point, the origin point being located within the degree indicator, the degree measurement component being extendable over a portion of the degree indicator so that an angle between a reference line and a point on the clear window to which the degree measurement component is extended is observable as the degree on the degree indicator over which the degree measurement component passes;
an attachment means on the clear window;
and the grid pattern that is printed on the clear window having X-axis and Y-axis indicators.

2. The tool for measuring symmetry of claim 1 wherein the grid pattern comprises a series of horizontal and vertical lines that intersect to form squares on the clear window.

3. The tool for measuring symmetry of claim 2 wherein the horizontal and vertical lines are denoted by a series of numbers or letters.

4. The tool for measuring symmetry of claim 1 wherein the degree indicator is located in the bottom center of the clear window.

5. The tool for measuring symmetry of claim 1 wherein the origin point is in the bottom center of the degree indicator.

6. The tool for measuring symmetry of claim 1 wherein the degrees measured by the degree indicator range from 0 to 180.

7. The tool for measuring symmetry of claim 1 wherein the attachment means on the clear window is either handheld handle or a floor stand.

8. A symmetrical measuring tool for used taxidermy to properly align head and face members of an animal, the symmetrical measuring tool comprising:
a larger window constructed so that through the larger window a subject can be seen;
the larger window having a series of horizontal and vertical lines that form an X and Y axis grid;
the grid being labelled with individual X and Y axis indicators so that each point of intersection on the grid is identifiable by an X and Y indicator combination;
a smaller clear window with degree markers at the bottom of the smaller clear window;
the smaller clear window being mounted to the larger clear window so that the smaller clear window can be slid horizontally on the larger clear window;
the smaller clear window having an origin point located on it;
and the smaller clear window being constructed so that the grid on the larger window and the subject can be seen through the smaller clear window.

9. The symmetrical measuring tool of claim 8 wherein the larger window is mounted to a floor stand or a handheld handle.

10. The symmetrical measuring tool of claim 8 further comprising a degree measurement component.

11. The symmetrical measuring tool of claim 10 wherein the degree measurement component is extendable from the origin point to a point on the larger window.

12. The symmetrical measuring tool of claim 11 wherein the angle between a reference line and the point to which the degree measurement component is extended is measurable by observing where the measurement component passes over the degree markers located on the smaller clear window.

13. The symmetrical measuring tool of claim 8 wherein the degree range on the smaller clear window is 0 to 180.

14. The symmetrical measuring tool of claim 8 wherein the grid is labelled using letters and numbers.

15. A method for providing a tool for determining the symmetry and balance of a subject comprising:
providing a clear window that can be held by a user;
the clear window being constructed of a clear material so that a subject can visible through the window;
placing an XY-axis grid on the clear window;
placing a degree indicator on the clear window;
placing an origin point on the window;
creating a reference line on the clear window or as part of the clear window;
including a degree measurement component capable of being extended from the origin point to a point on the clear window;
and including a degree measurement component that is used by a user to measure the angle between the reference line and point on the clear window.

16. The method of claim 15 further comprising attaching one end of the degree measurement component to the origin point.

17. The method of claim 15 wherein the degree indicator indicates a range of degrees from 0 to 180.

18. The method of claim 15 further comprising labelling the X and Y axis gridlines with unique indicators so that each point of intersection is identifiable by an X and Y coordinate.

19. The method of claim 15 further comprising attaching a handle to the clear window.

20. The method of claim 15 further comprising attaching a floor stand to the clear window.
